(19) United States
(12) Patent Application Publication
(10) Pub. No.: US 2013/0263174 A1
(43) Pub. Date: Oct. 3, 2013

(54) TELEVISION PROGRAMMING CUSTOMIZATION THROUGH TEMPORARY SUBSCRIPTION CHANGES

(71) Applicants: Jimshade Chaudhari, Highlands Ranch, CO (US); Vivek Khemka, Greenwood Village, CO (US)

(72) Inventors: Jimshade Chaudhari, Highlands Ranch, CO (US); Vivek Khemka, Greenwood Village, CO (US)

(73) Assignee: DISH Network L.L.C., Englewood, CO (US)

(21) Appl. No.: 13/433,153

(22) Filed: Mar. 28, 2012

(51) Int. Cl. H04N 21/45

(52) U.S. Cl. 725/28

(57) ABSTRACT

Techniques are disclosed for providing customized television programming through temporary subscriptions. According to certain embodiments, a television delivery service system is configured to allow a subscriber to gain access to one or more channels not available under a first subscription package by granting a temporary subscription to a second subscription package. At the end of the temporary subscription, the subscriber's access is returned to the first subscription package. This allows a subscriber to gain access to additional channels not available under the subscriber's current subscription program without having to upgrade to a new subscription plan altogether.

### BACKGROUND

Content delivery services such as telephone, Internet, wireless/cellular communications, music, television, and the like are often subscription based. Typically, subscribers are limited to a certain subscription plan or package during a period of time, such as a billing cycle (e.g., monthly) or a contract period (e.g., one or two years), during which the subscriber has little ability to alter or switch the subscription plan. With regards to television, for example, a television service provider is often limited in the ability to allow a subscriber to switch a subscription package in the middle of a billing cycle due to contractual limitations with content providers, among other concerns.

Such an arrangement may be inconvenient for the subscribers, who temporarily may want to access data not included in their current subscription plan, without permanently switching their subscription plan or waiting until the end of a billing cycle or contractual period to do so. This inflexibility in such subscription plan arrangements can lead to reduced customer satisfaction among subscribers and reduced revenue for data delivery service providers.

### SUMMARY

Techniques are disclosed for providing customized content programming through temporary subscriptions. According to certain embodiments, a content delivery service system is configured to allow a subscriber to gain access to one or more content streams or channels not available under a first subscription package by granting a temporary subscription to a second subscription package. At the end of the temporary subscription package, the subscriber's access is returned to the first subscription package.

According to one embodiment, a method for providing customized content programming to a content presentation device is provided. The method includes providing access to a plurality of content streams available with a first subscription package, receiving a first request for access to a requested content stream, and determining that the requested content stream is not available with the first subscription package. The method further includes identifying a second subscription package with which the requested content stream is available, and automatically enabling a temporary subscription to the second subscription package for a certain period of time. The enabling the temporary subscription allows access to the requested content stream during the certain period of time. Finally, the method includes restoring the first subscription package after the certain period of time.

The method for providing customized content programming to a content presentation device can include one or more of the following features. Automatically enabling the temporary subscription to the second subscription package can include sending via a data communication link a request for access to the temporary subscription to the second subscription package, and receiving an indication that access has been granted. Indicating, on a menu presented to the content presentation device, that the requested content stream is available with the second subscription package, where the indicating occurs prior to receiving the first request for access to the requested content stream. Filtering a list of content streams such that only content streams that are available with the second subscription package are displayed on the menu. The certain period of time can end after a certain length of time, a certain time of day, or a certain date. Determining that a certain content program associated with the requested content stream comprises a program series scheduled to air at recurring time periods, and automatically enabling a corresponding temporary subscription to the second subscription package for each of one or more of the recurring time periods the program series is scheduled to air.

The method for providing customized content programming to a content presentation device additionally can include one or more of the following features. Receiving a second request for access to the requested content stream, analyzing a history of requests for access to the requested content stream, and providing, on a menu presented to the content presentation device, an option to change subscriptions from the first subscription package to the second subscription package, based, at least in part, on the history of requests for access to the requested content stream. Determining that a content program associated with the requested content stream will end after the certain period of time, and providing, on a menu presented to the content presentation device, an option to extend the certain period of time. The first request for access to the requested content stream can include a request to record a content program associated with the requested content stream. Determining that a certain content program associated with the requested content stream comprises a program series scheduled to air at recurring times, and for each of one or more of the recurring times the program series is scheduled to air, enabling a corresponding temporary subscription to the second subscription package, and scheduling a recording to record a at least a portion of the program series during the recurring time.

According to another embodiment, a system for providing customized content programming is provided. The system includes a first communication interface configured to receive a plurality of content streams, an output interface configured to be coupled with an end-user presentation device, and a processing system, coupled to the first communication interface and the output interface. The processing system is configured to enable the first communication interface to access to a plurality of content streams available with a first subscription package, receive a first request for access to a requested content stream, and determine the requested content stream is not available with the first subscription package. The processing system is further configured to identify a second subscription package with which the requested content stream is available, automatically enable a temporary subscription to the second subscription package for a certain period of time, such that access to the requested content stream is allowed, and restore access to the first subscription package after the certain period of time.

The system for providing customized content programming can include one or more of the following features. The processing system can be configured to automatically enable the temporary subscription to the second subscription package by sending via a data communication link a request for the temporary subscription to the second subscription package. The system can include a second communication interface, where the processing system is configured to send the request for the temporary subscription to the second subscription package using the second communication interface. The processing system can be further configured to indicate, on a menu presented to the end-user presentation device, that the requested content stream is available with the second subscription package, where the indicating occurs prior to receiving the first request for access to the requested content stream. The processing system can be further configured to filter a list of content streams such that only content streams that are available with the second subscription package are displayed on the menu. The system can be integrated into the end-user presentation device. The processing system can be further configured to determine that a certain program associated with the requested content stream comprises part of a program series scheduled to air a plurality of times, and enable a corresponding temporary subscription to the second subscription package for each of one or more of the plurality of times the program series is scheduled to air.

The system for providing customized content programming additionally can include one or more of the following features. The processing system can be further configured to receive a second request for access to the requested content stream, analyze a history of requests for access to the requested content stream, and provide, on a menu presented to the end-user presentation device, an option to change subscriptions from the first subscription package to the second subscription package, based, at least in part, on the history of requests for access to the requested content stream. The processing system is further configured to determine that a program associated with the requested content stream will end after the certain period of time, and provide, on a menu presented to the content presentation device, an option to extend the certain period of time. The system can include a memory, where the first request for access to the requested content stream comprises a request to record a program associated with the requested content stream. The processing system can be further configured to determine that a certain program associated with the requested content stream comprises a program series scheduled to air at recurring times, and, for each of one or more of the recurring times the program series is scheduled to air, enable a corresponding temporary subscription to the second subscription package, and schedule a recording to record a portion of the program series during the recurring time.

According to yet another embodiment, a system for providing customized content programming, is provided. The system can include access means for enabling an content presentation device to access to a plurality of content streams available with a first subscription package, receiver means for receiving a first request for access to a requested content stream, and evaluation means for determining the requested content stream is not available with the first subscription package. The system can further include identification means for identifying a second subscription package with which the requested content stream is available, enabling means for automatically enabling a temporary subscription to the second subscription package for a certain period of time, such that access to the requested content stream is allowed, and restoring means for restoring the first subscription package after the certain period of time.

The system for providing customized content programming can include one or more of the following features. The enabling means can include communication means for sending via a data communication link a request for access to the temporary subscription to the second subscription package, and receiving an indication that access has been granted. The system can include indication means for indicating, on a menu presented to the content presentation device, that the requested content stream is available with the second subscription package, where the indicating occurs prior to receiving the first request for access to the requested content stream. The indication means can include means for filtering a list of content streams such that only content streams that are available with the second subscription package are displayed on the menu. The certain period of time can end after a certain length of time, a certain time of day, or a certain date. The system can include determining means for determining that a certain content program associated with the requested content stream comprises a program series scheduled to air at recurring time periods, where the enabling means automatically enables a corresponding temporary subscription to the second subscription package for each of one or more of the recurring time periods the program series is scheduled to air.

The system for providing customized content programming additionally can include one or more of the following features. The receiver means can include means for receiving a second request for access to the requested content stream, further comprising analysis means for analyzing a history of requests for access to the requested content stream, and presentation means for providing, on a menu presented to the content presentation device, an option to change subscriptions from the first subscription package to the second subscription package, based, at least in part, on the history of requests for access to the requested content stream. The system can include determination means for determining that a content program associated with the requested content stream will end after the certain period of time, and presentation means for providing, on a menu presented to the content presentation device, an option to extend the certain period of time. The receiver means can be configured to receive the first request for access to the requested content stream that comprises a request to record a content program associated with the requested content stream. The system can include determination means for determining that a certain content program associated with the requested content stream comprises a program series scheduled to air at recurring times, and means for, for each of one or more of the recurring times the program series is scheduled to air, enabling a corresponding temporary subscription to the second subscription package, and scheduling a recording to record a at least a portion of the program series during the recurring time.

Numerous benefits are achieved over conventional techniques. For example, a subscriber is given customized access to a content stream or channel not available under the subscriber's current subscription program without having to upgrade to a new subscription plan altogether. Additionally, the subscriber will also have access to other streams or channels available under the temporary subscription. Such temporary access to content programming can be far more cost effective for a consumer than purchasing content for download or upgrading to a new subscription plan. These and other embodiments, along with many of its advantages and features, are described in more detail in conjunction with the text below and attached figures.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a simplified block diagram of an embodiment of a content service delivery system.

FIG. 2 is a simplified block diagram of another embodiment of a content service delivery system.

FIGS. 3A and 3B are flow diagrams of methods for enabling a temporary subscription to a new subscription package.

FIG. 4 is a flow diagram of an embodiment of a method for prompting a user to upgrade to a different subscription package based on an analysis of viewing history.

FIG. 5 is a flow diagram of an embodiment of a method for automatically enabling temporary subscriptions based on a program is provided.

FIGS. 6A-6G are illustrations of an example on-screen menu that enables the temporary subscriptions discussed herein.

FIG. 7 is a simplified block diagram of an embodiment of a computer system.

### DETAILED DESCRIPTION

Embodiments are directed to enabling a subscriber to purchase a temporary subscription to a certain subscription plan or package and automatically restoring the subscriber to a previous subscription plan or package after the temporary subscription has expired. Such functionality allows a subscriber to access content and/or other services the subscriber would otherwise fail to receive, while also allowing a content delivery service provider to capture increased revenue from these temporary subscriptions. In sum, this customization of content delivery results in increased value for the subscriber and increased revenue for the content delivery service provider.

Although embodiments detailed herein below are directed toward providing television service content, the principles easily can be extended to other types of content delivery services, such as music, games, books, periodicals and the like. In addition, the terms “television” or “television service” can include traditional television programming, such as linear television program, as well as other types of audio, video and/or audio/video content, such as on-demand video content, streaming video content and the like delivered via any type of content delivery systems, such as a cable, satellite, cellular/wireless, Internet/IP and/or any other content delivery technology or system currently known or hereinafter developed. Furthermore, embodiments herein describe television receivers (such as set-top boxes) being communicatively coupled with a television. However, the television reception functionality can also be incorporated into a presentation device, such as a television with an integrated cable, satellite or IPTV receiver. However, the techniques discussed herein can be extended to any of a variety of other end-user presentation devices, such as, for example, computers, tablets, hand-held mobile devices, cell phones, e-readers, radios or other music receiving systems, and the like. A person of ordinary skill in the art will recognize various alterations, additions, omissions, and substitutions.

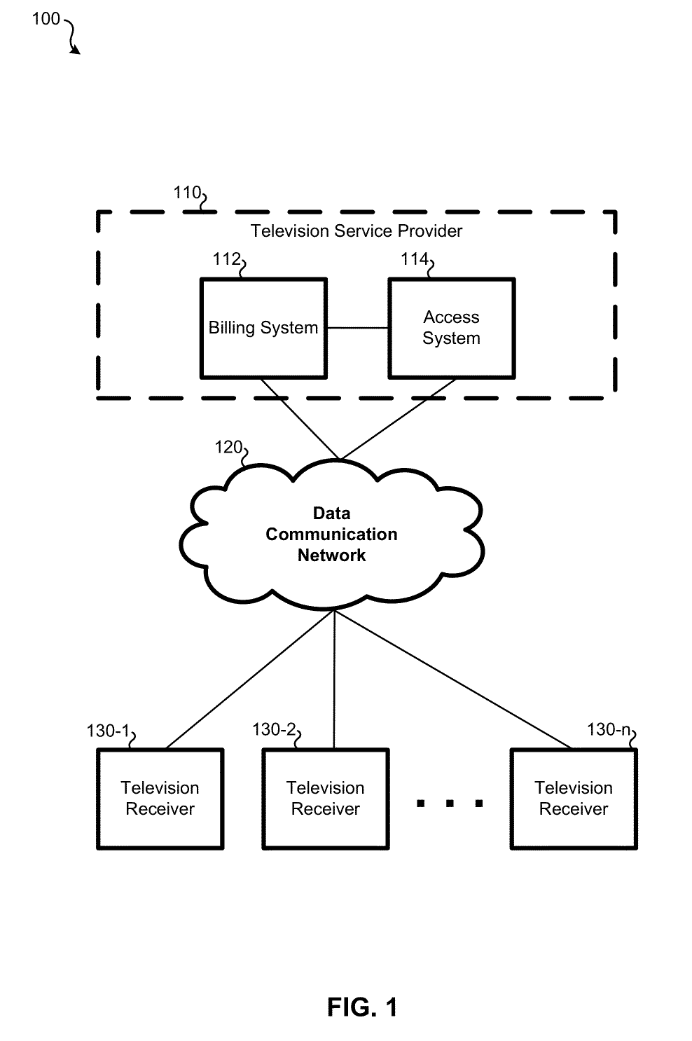

FIG. 1 is a simplified block diagram of a television delivery service system 100, according to one embodiment. The television delivery service system 100 includes a television service provider 110 that provides the content for distribution to various television receivers 130 via a data communication network 120. The television delivery service system 100 can have any number of television receivers 130 (denoted as 130-1 through 130-n), depending on the scalability of the infrastructure and the number of subscribers, among other factors.

In the pictured embodiment, the television service provider 110 includes a billing system 112 and an access system 114. Among other functions, the billing system 112 can determine a subscription package associated with each of the television receivers 130 communicatively coupled with the data communication network 120. Subscription packages can vary widely to accommodate differing budgets and desired programming of the subscribers. For example, a basic subscription package may include a relatively small amount of popular television channels, while other subscription packages can include any of a wide variety of additional channels. Subscription packages can include, for example, a collection of sports channels, movie channels, specialty channels, music channels, gaming channels, and more.

The billing system 112 can be communicatively coupled with the access system 114, to provide the appropriate programming to each of the various television receivers 130. For example, if a subscriber associated with a certain television receiver 130-1 subscribes to a sports subscription package, the billing system 112 can verify that the corresponding payment for the sports subscription package has been made. The billing system 112 can then communicate with the access system 114 to ensure that the certain television receiver 130-1 is granted access to the sports (and other) channels associated with the sports subscription package. The access system 114 acts as a gatekeeper, enabling the various television receivers 130 to access the channels to which they are subscribed.

In the illustrated television delivery service system 100, the billing system 112 and access system 114 are provided as distinct blocks. However, these systems can be combined or further separated out into additional distinct systems, depending on desired functionality. Moreover, the billing system 112 and/or access system can be implemented using any combination of hardware and/or software. For example, these systems may be a combination of physical and/or virtual computer servers.

The data communication network 120 is the infrastructure by which the television programming is provided to the various television receivers. It can comprise any combination of a variety of data communication systems, for example, cable, satellite, wireless/cellular, or Internet systems, or the like, utilizing various transport technologies and/or protocols, such as radio frequency (RF), optical, satellite, coaxial cable, Ethernet, cellular, twisted pair, other wired and wireless technologies, and the like. The network type can comprise packet- and/or circuit-type switching, and can include one or more open, closed, public, and/or private networks, including the Internet, depending on desired functionality, cost concerns, and other factors.

The television receivers 130 also can vary in form and function. In some embodiments, for example, a television receiver 130 may be integrated into a television, computer, or other end-user display or presentation device. In other embodiments, the television receiver 130 may be a separate device, such as a set-top box, connected with the data communication network 120 through a communication interface, and connected with a television (or other end-user presentation device) through an output interface. The television receivers enable the television to access the television channels of the subscription package to which the subscriber has subscribed. Furthermore, the television receivers 130 can be communicatively coupled with and/or integrated into recording or storage devices, such as digital video recorders (DVRs), which enable a subscriber to record television programs for later viewing.

Due to various factors, such as agreements with content providers, the television service provider may be limited to a certain subscription package during a period of time, such as a billing cycle (e.g., monthly) or a contract period (e.g., one or two years), during which the subscriber has little ability to alter or switch the subscription plan. The television delivery service system 100 provided herein, however, enables a subscriber to temporarily subscribe to a new subscription plan to access content that would either require a long-term package upgrade or otherwise be unavailable.

As provided herein below, the subscriber can customize television programming by selecting and authorizing a temporary subscription to a new subscription package for a limited period of time. After the limited period of time, the subscription automatically returns to the original subscription package to which the subscriber has subscribed. Although, in some embodiments, the subscriber may authorize a temporary subscription through a device other than the television receiver 130 (e.g., a personal computer, smart phone, tablet, etc.), other embodiments enable a subscriber to select and authorize the temporary subscription using a television receiver 130.

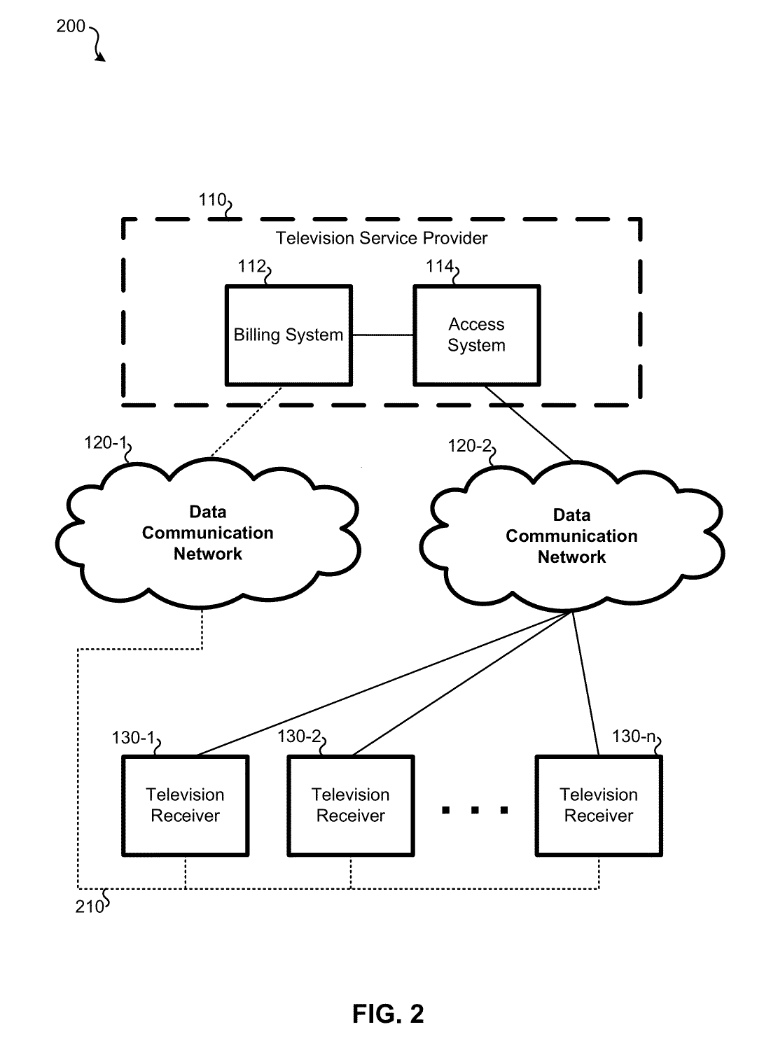

In the illustrated television delivery service system 100, the data communication network 120 can provide duplex (i.e., two-way) communication between the television service provider 110 and the television receivers 130. This allows a television receiver 130 to communicate a subscriber's request for a temporary subscription to a new subscription package via the data communication network 120. In other embodiments, such as the television delivery service system 200 shown in FIG. 2, a first data communication network 120-2 that provides television programming from the access system 114 to the television receivers 130 may only provide simplex (i.e., one-way) communication. Such a data communication network 120-2 can include, for example, satellite communications. In this case, the television receivers 130 can communicate with the billing system 112 (and/or other components of the television service provider 110) using a different communication link 210 (i.e., a “back channel”) via a separate data communication network 120-1, such as the Internet.

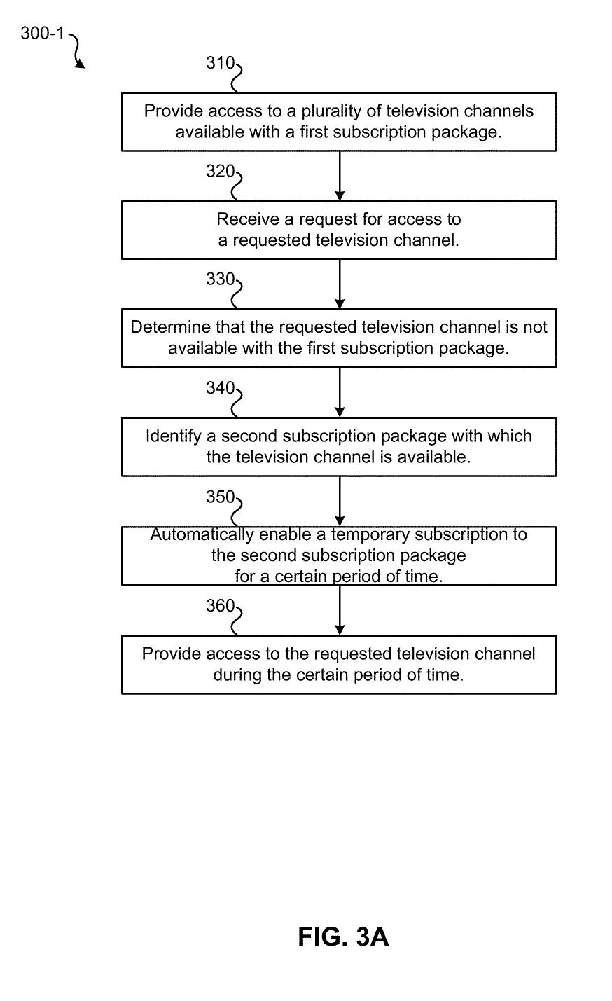

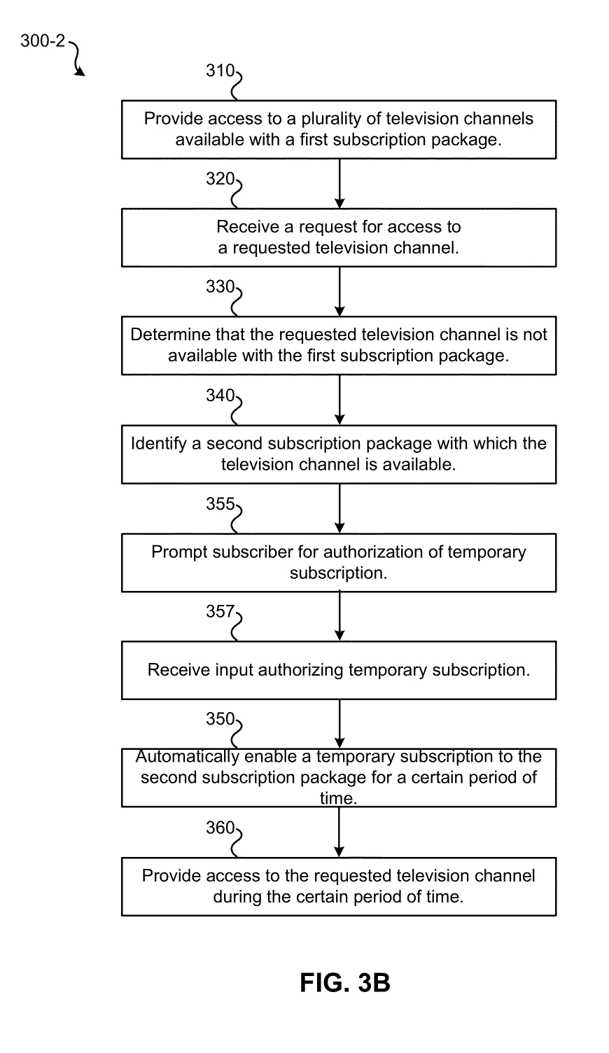

FIG. 3A is a flow diagram illustrating a first embodiment of a method 300-1 for providing customized television programming to a television by enabling a temporary subscription to a new subscription package. The method 300-1 can, for example, be performed by a television receiver 130 and/or other components of the television delivery service systems 100 and 200 of FIGS. 1 and 2, respectively. At block 310, a subscriber is provided access to a plurality of television channels available with a first subscription package to which the subscriber has subscribed. Depending on the functionality of the television delivery service system, the access can be determined by a billing system 112, access system 114, and/or television receiver 130. In some embodiments, for example, the billing system 112 can indicate the first subscription package to the access system 114, which communicates to the corresponding television receiver 130 which channels to make available.

At block 320, a request for access to a requested television channel is received. A subscriber can make such a request in various ways. For example, the request could be made by simply pushing a button on a remote control to change the channel, by selecting the requested television channel using an on-screen menu displayed on the television, or by using another interface, such as an Internet web interface or mobile application on a mobile device. Additionally or alternatively, the request for access to the requested television channel may be made when a user chooses to record a television program on the requested television channel using a DVR. In this latter case, for example, a subscriber may utilize an on-screen menu (or other interface as discussed above) to select a television program currently airing, or scheduled to air on the requested television channel at a future point in time. If the user then chooses to record the selected television program, a request for access to the requested television channel is made.

At block 330, it is determined that the requested television channel is not available with the first subscription package. This determination can be made, for example, by a television receiver 130 that restricts access to television channels other than those available in the first subscription package, or by a module or functionality at television service provider 110, such as billing system 112 or access system 114. At block 340, a second subscription package, with which the requested television channel is available, is then identified. In certain situations, the second subscription package may be selected from two or more subscription packages with which the channel is available. In this case, the subscriber can be prompted to select, from a list of prospective subscription packages, which subscription package is preferred for the temporary upgrade.

At block 350, a temporary subscription to the second subscription package is automatically enabled for a certain period of time. The certain period of time can vary, depending on functional and contractual considerations. In some embodiments, for example, the certain period of time can end after a certain length of time (e.g., 12 hours, one day, one week, etc.), a certain time of day (e.g., 12 am), or a certain date.

The temporary subscription can be enabled in a variety of ways. For example, the television receiver 130 can communicate with the billing system 112 to request the temporary subscription to the second subscription package. The request may contain information identifying the television receiver 130 and/or subscriber, as well as information regarding the requested subscription package, duration of time the subscription is requested, billing information, and more. The billing system 112 can charge the subscriber for the temporary subscription (e.g., access a credit card system for a credit card payment) at the time of the request, or simply bill the subscriber later, in accordance with its established billing practices. The billing system 112 can then indicate to the television receiver 130 that the request has been approved. Additionally or alternatively, the billing system 112 can indicate the change in the subscription to the access system 114, which can then communicate with the corresponding television receiver 130 to enable the additional channels included in the second subscription package.

In another embodiment, a conditional access system of the receiver 130 may be configured to generate a temporary authorization for the second subscription package internally. For example, a smart card may generate a temporary authorization (e.g., an impulse entitlement management message (EMM)) for the temporary subscription and provide the EMM to the receiver 130. The smart card may store information regarding the purchase and periodically report the purchase information to the provider for proper billing (e.g., weekly, monthly). In at least one embodiment, the receiver 130 may have a specified credit limit, such that the smart card or other internal conditional access system is unable to authorize the temporary subscription. The receiver 130 may then report previously stored purchase to the provider for billing and receiver information from the provider that releases the credit limit such that additional purchases can be made through the receiver 130.

At block 360, access to the requested television channel is provided during the certain period of time, after which the subscription is automatically restored to the first subscription package. It can be noted that, in addition to the requested television channel, the subscriber can have access to any additional channels included in the second subscription package during the certain period of time. In one embodiment, the billing system 112 can track the temporary subscription to ensure the subscription automatically reverts back to the first subscription package. At the end of the certain period of time, for example, the billing system 112 can indicate to the access system 114 that the subscription of the corresponding television receiver 130 has returned to the first subscription package, in which case the access system 114 limits the access of the corresponding television receiver 130 to display only those television channels available with the first subscription package. According to certain embodiments, a television receiver 130 and or other components of a television delivery service system 100, 200 can be configured to determine that a television program being viewed and/or recorded will end after the temporary subscription ends. In this case, the television receiver 130 can provide an on-screen prompt to allow the subscriber to extend the temporary subscription (or purchase a new temporary subscription.)

FIG. 3B is a flow diagram of an embodiment of a method 300-2 for enabling a temporary subscription to a new subscription package, similar to the method 300-1 of FIG. 3B, but with additional blocks for user input. These additional steps can be desirable when a subscriber is requesting a temporary subscription for the first time. At block 355, for example, the subscriber is prompted to provide authorization of the temporary subscription. And at block 357, input authorizing the temporary subscription is received. The prompt and input can be conducted through a user interface, such as an on-screen menu displayed on the television. The television receiver 130, for example, can cause the television to display a text box prompting the subscriber to provide authorization for the temporary subscription. In response, the subscriber can authorize the temporary subscription by selecting an “authorize” or “OK” button on the on-screen menu using a remote control. An example of such an on-screen menu is provided in the appended figures and described in more detail herein below.

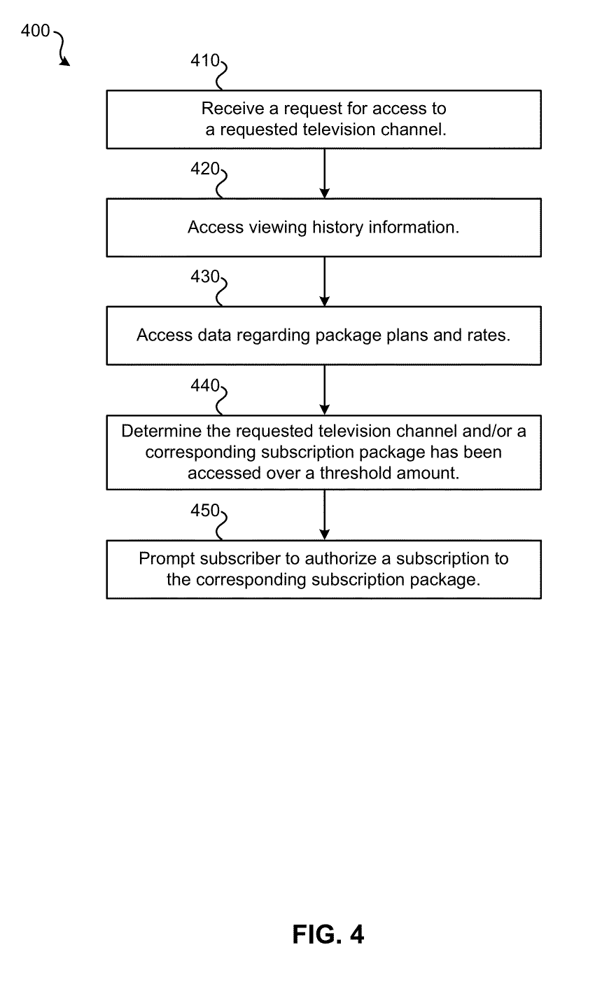

Television receivers 130 and/or other components of the television delivery service systems 100 and 200 of FIGS. 1 and 2 also can be configured to analyze viewing history and provide additional information to a subscriber based on the analysis. For example, FIG. 4 is a flow diagram of an embodiment of a method 400 for prompting a user to upgrade to a different subscription package based on an analysis of viewing history. At block 410, a request for access to a requested television channel is received, similar to block 320 of FIGS. 3A and 3B. In the method 400, however, viewing history information is accessed at block 420. This viewing history information can include information regarding a certain channel and/or subscription packages that the subscriber has made in the past. Furthermore, at block 430, data regarding package plans and rates is also accessed.

The information from blocks 420 and 430 enables a television receiver 130 (or other component) to determine whether the requested television channel and/or the corresponding subscription package has been accessed over a threshold amount, at block 440. For example, a television receiver 130 determines that a subscriber has made four temporary subscriptions in the current month to a requested television channel and/or corresponding subscription package. Each temporary subscription costs $4. If the television receiver 130 or backend portion of system 100 determines that a subscription upgrade to the certain subscription package would cost the subscriber $20 a month, then the television receiver 130 could prompt the subscriber to upgrade to the corresponding subscription package after receiving the fifth request to access the certain channel and/or certain subscription package. Such an upgrade would enable the user to access the requested television channel (and other channels in the corresponding subscription package) for the same price as five temporary upgrades. As illustrated by this example, the threshold amount of block 440, could be determined by calculating the number of temporary subscriptions to a certain subscription package it would take to equal or surpass the cost of an upgrade to the certain subscription package during a billing cycle.

Finally, at block 450, the subscriber is prompted to authorize a subscription to the corresponding subscription package. The prompt can be provided in an on-screen menu and can indicate the additional savings and value provided in an upgrade. As provided herein, as a subscription “upgrade,” in contrast to a temporary subscription, is a change in a subscription that does not automatically revert back to an original subscription package after a temporary period of time.

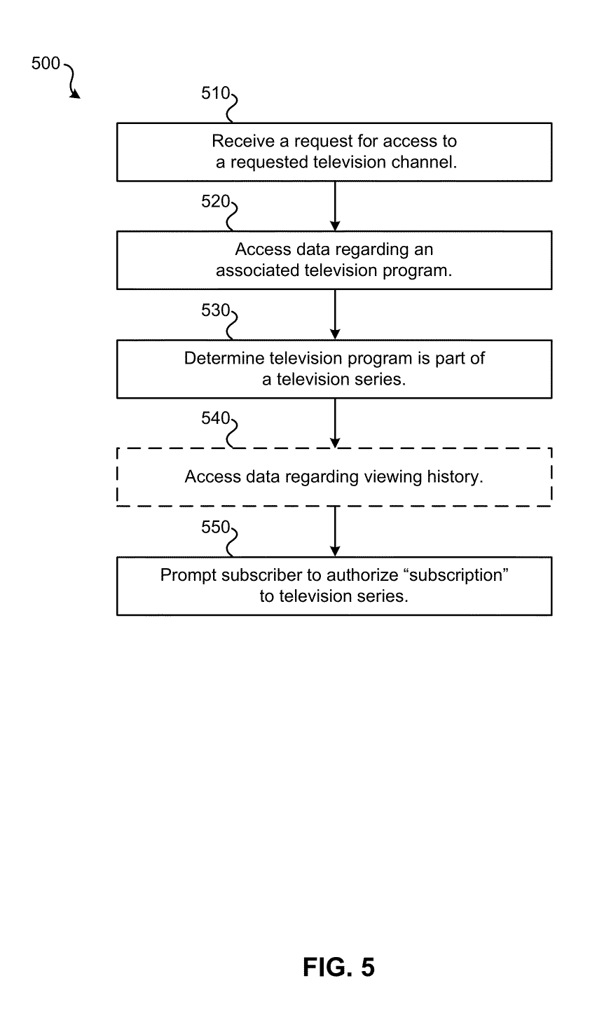

The temporary package subscriptions discussed herein also can be based on a particular television program. In FIG. 5 a flow diagram of an embodiment of a method 500 for automatically enabling temporary subscriptions based on a television program is provided. As with methods shown in FIGS. 3A-4, this method 500 can be performed by television receivers 130 and/or other components of the television delivery service systems 100 and 200, and can include a request for access to a requested television channel, at block 510.

At block 520, data regarding an associated television program is accessed. And, at block 530, it is determined that the television program is part of a television series (i.e., recurring series of related television programs). Here, the television receiver can identify a program (e.g., a program currently showing or showing at a future time) on a requested television channel and determine whether related programming will occur later. If so, at block 550, the subscriber can be prompted to authorize a “subscription” to the television series. In other words, the television receiver 130 (and/or other components) can schedule recurring temporary subscriptions to correspond to the recurrences of the television series so that the subscriber does not have to re-authorize future temporary subscriptions for that television series.

Such functionality can be particularly helpful when incorporated with recording technology. For example, when integrated with a DVR, this can allow a user not only to schedule automatic temporary subscriptions for multiple episodes of a television series, but it also can schedule recordings so that the episodes are recorded.

Optionally, as shown by block 530, a television receiver can access data regarding viewing history to determine whether one or more episodes of the television series have been viewed before to anticipate whether the subscriber would want to “subscribe” to the television series. Moreover, the functionality of method 500 can include the functionality of the method 400 of FIG. 4 to determine whether it would be more cost effective, over a billing cycle, for a subscriber to setup automatic temporary subscriptions to a certain subscription package, or to simply upgrade to the certain subscription package. If the latter is the case, the television receiver can prompt the subscriber to upgrade as part of the “subscription” to the television series.

It should be appreciated that the specific steps illustrated in FIGS. 3A-5 provide particular methods for providing customized television programming. Other sequences of steps may also be performed according to alternative embodiments. For example, alternative embodiments may perform the steps outlined above in a different order. Moreover, the individual steps illustrated in FIGS. 3A-5 may include multiple sub-steps that may be performed in various sequences as appropriate to the individual step. Furthermore, additional steps may be added or removed depending on the particular applications. One of ordinary skill in the art would recognize many variations, modifications, and alternatives.

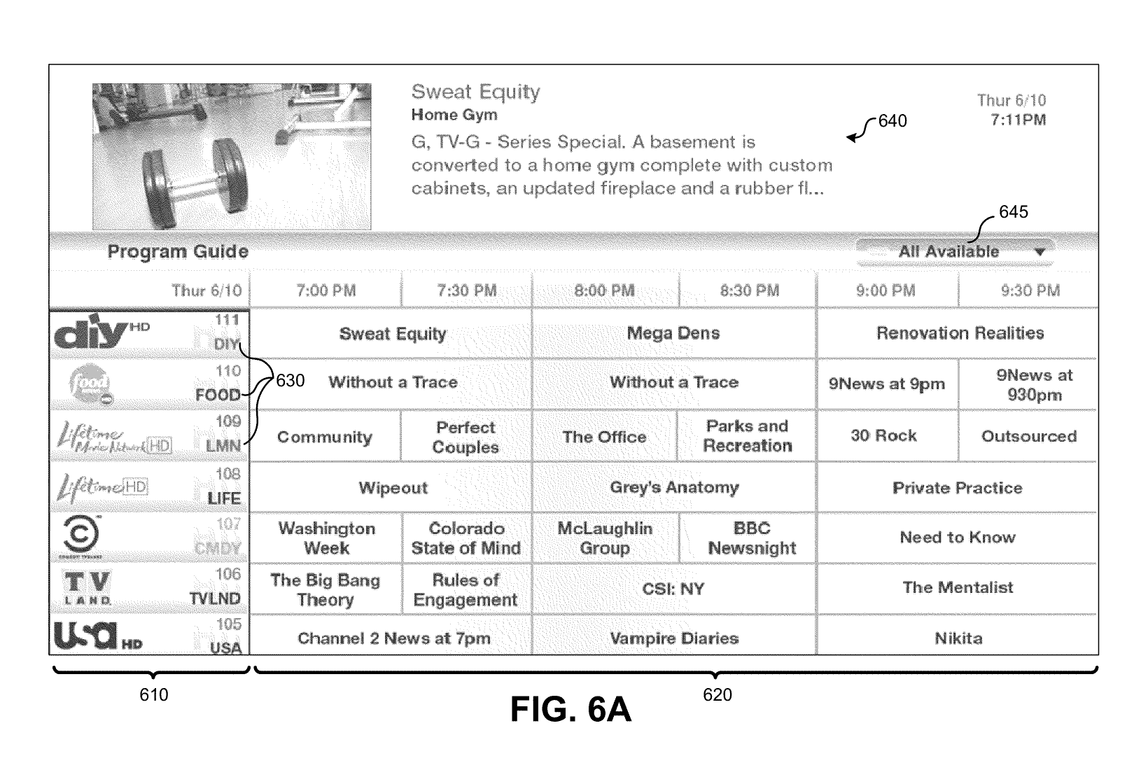

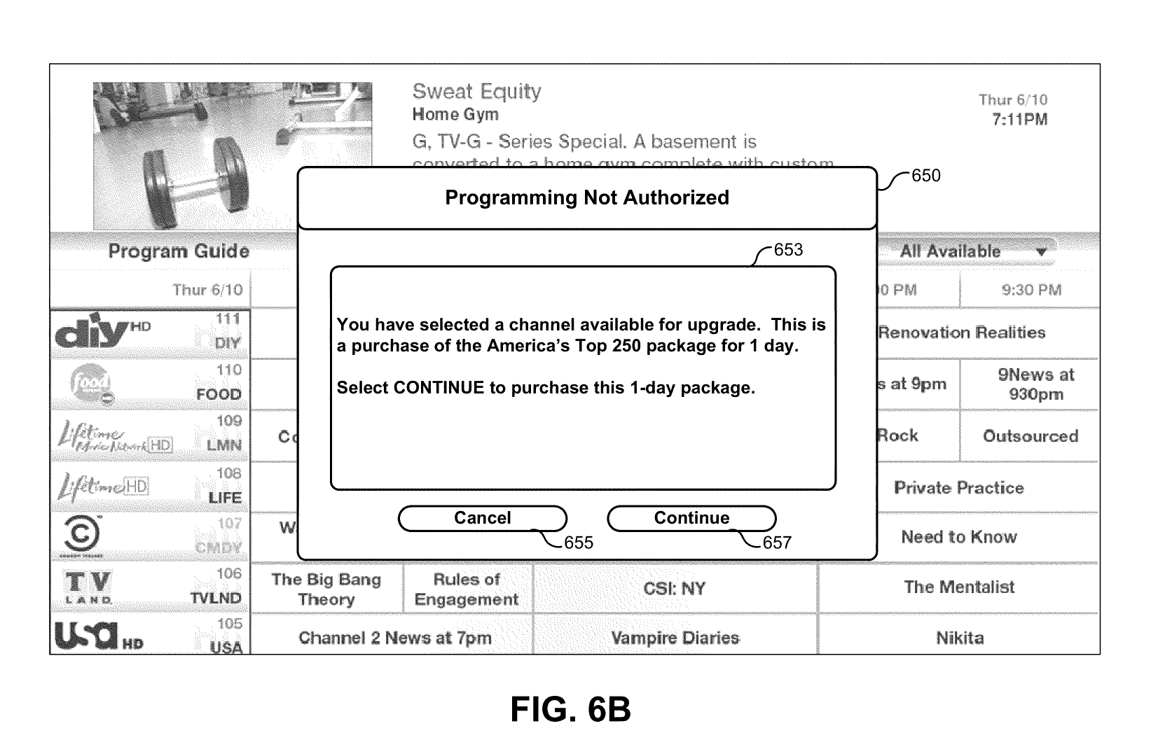

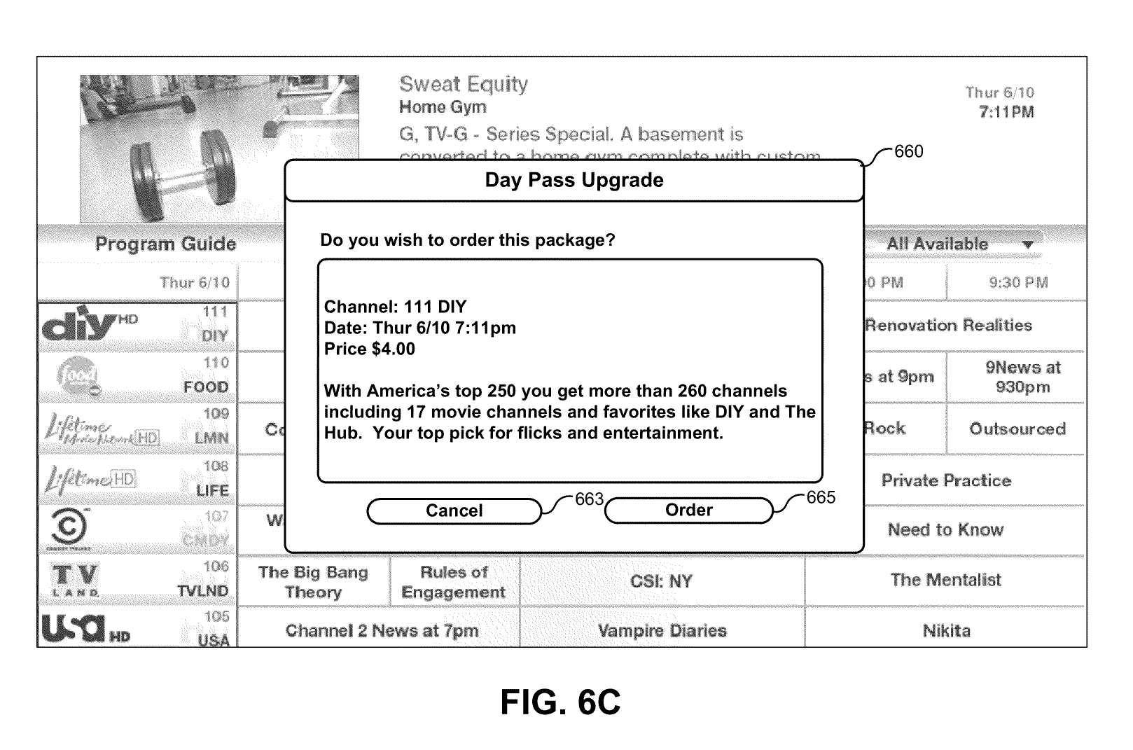

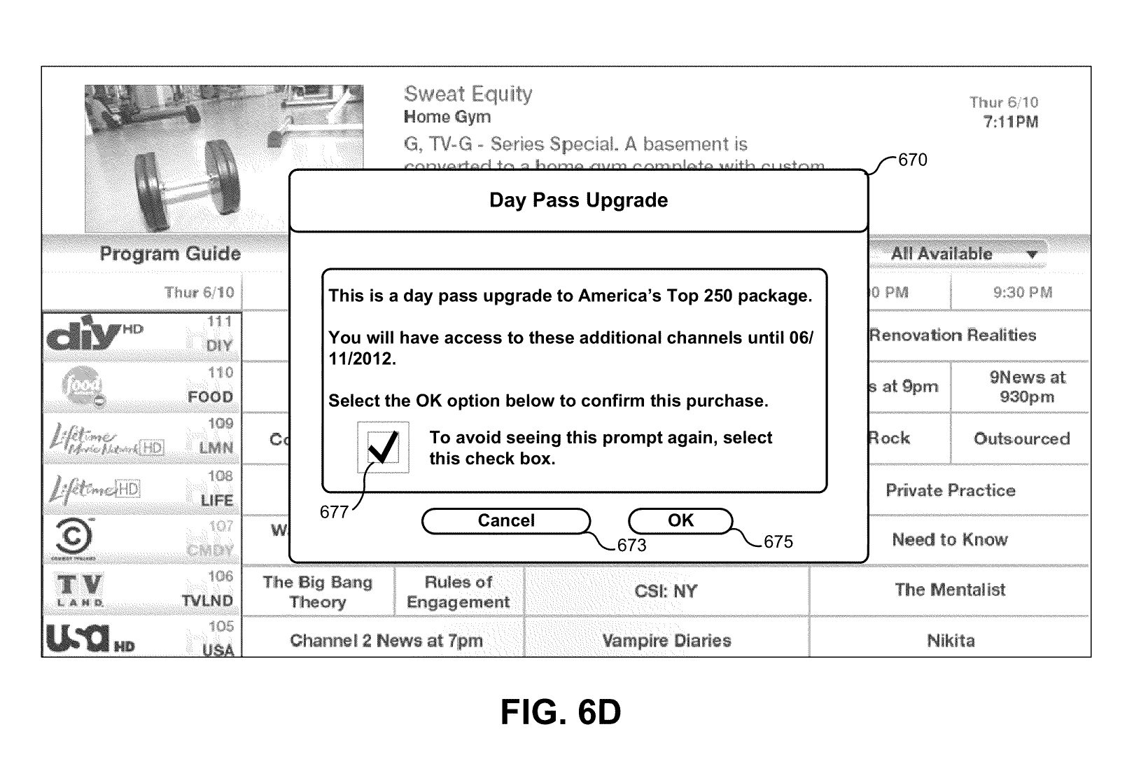

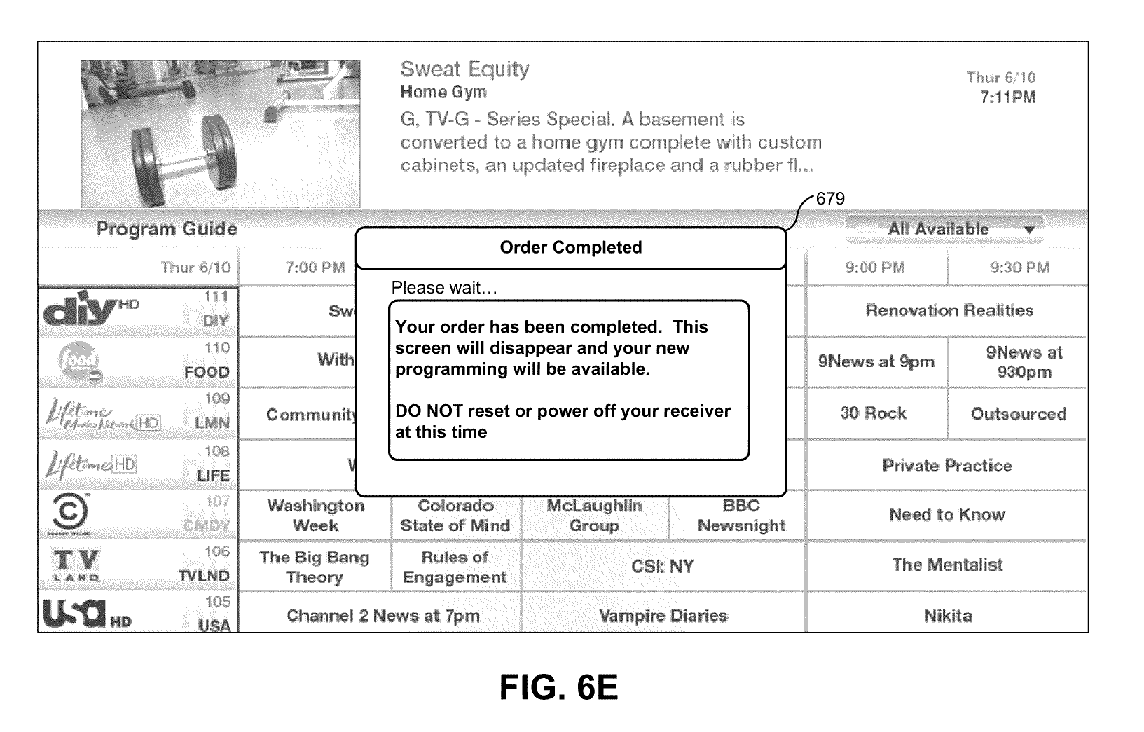

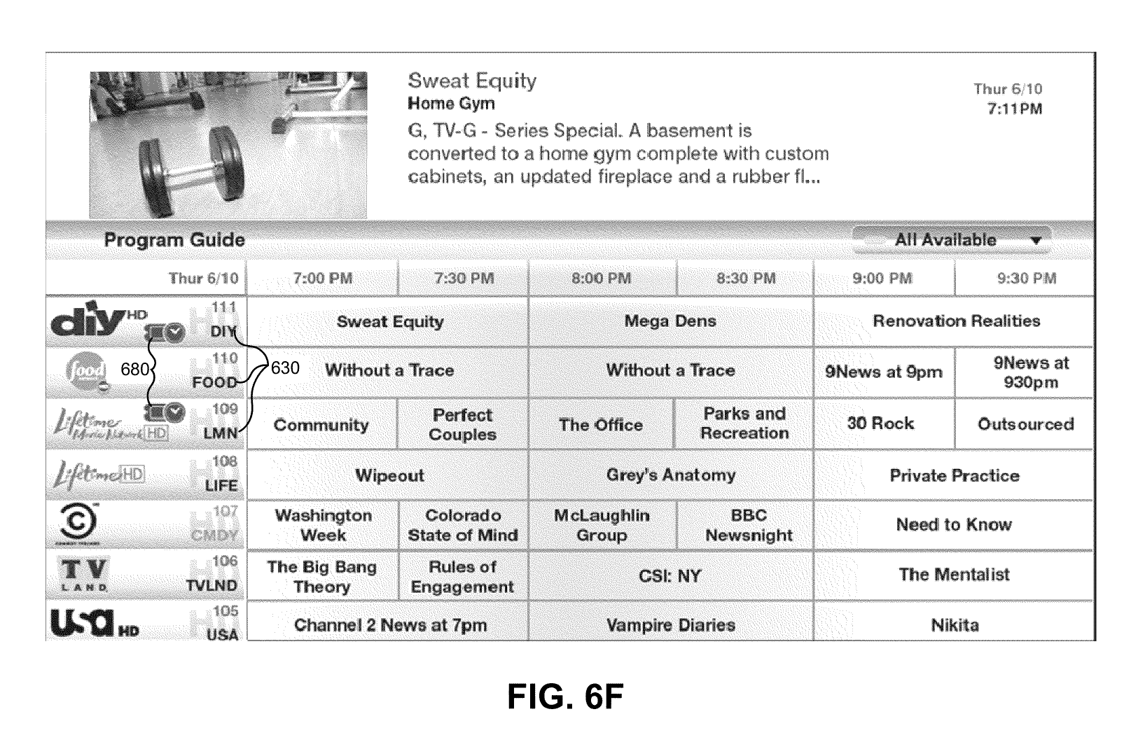

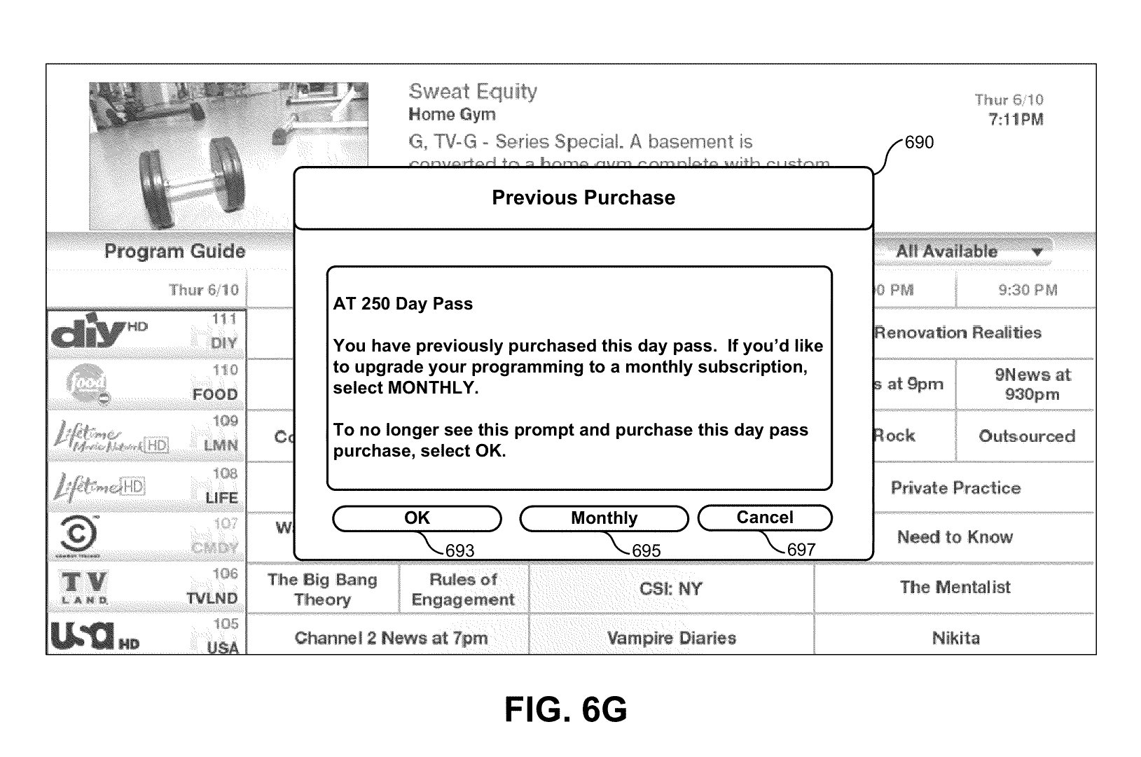

FIGS. 6A-6G are illustrations of an example on-screen menu that can be utilized to enable the temporary subscriptions discussed herein. In FIG. 6A, the on-screen menu includes a first portion 610 indicating available channels and a corresponding second portion 620 displaying the television programs aired by those available channels over a user-selectable time period. The menu can be scrolled up or down to reveal additional available channels, and different filters may be applied by using the drop-down menu 645 to display only channels of a certain group. For example, channels may be filtered by favorites, content (e.g., sports, movies, news, etc.), and by subscription package. A descriptive portion 640 includes a brief description of a selected television program.

The on-screen menu can also indicate which channels are available to a subscriber under the subscriber's current subscription package, and which channels are available under another subscription packages. For example, the channel names 630 can be color coded such that channel names for channels available under the subscriber's current subscription package appear in black, while those available with a second and third subscription package appear in green and orange, respectively. This enables a user to determine whether the channel is available, and also which groups of channels (e.g., those having green channel names or orange channel names) are available under different subscription packages. In other embodiments, other types of indicators can provide similar functionality.

FIG. 6B illustrates a pop-up window 650 that appears on the on-screen menu when a subscriber selects a channel not available under the subscriber's current subscription. Here, a text box 653 indicates to a user that the selected channel is available under a different subscription package (“America's Top™ 250”), which can be purchased under a temporary subscription. The subscriber can cancel the process by selecting the “cancel” button 655, or continue the temporary subscription process by selecting the “continue” button 657.

FIG. 6C illustrates a subsequent pop-up window 660 providing additional details regarding the pricing and subscription package of the temporary subscription. The subscriber can cancel the process by selecting the “cancel” button 663, or continue the temporary subscription process by selecting the “order” button 665.

FIG. 6D illustrates yet another pop-up window 670 providing some final details, including the duration of the temporary subscription. The subscriber can expedite subsequent temporary upgrades by selecting a checkbox 677. To order the temporary subscription, the subscriber can select the “OK” button 675. Otherwise, the subscriber can cancel the process by selecting the “cancel” button 673. FIG. 6E illustrates a processing pop-up window 679 confirming that the temporary subscription has been ordered and is being processed.

FIG. 6F illustrates the on-screen menu after the temporary subscription has been successfully processed. It is similar in appearance to the on-screen menu prior to the temporary subscription, as shown in FIG. 6A. Additionally, however, are indicators that the subscriber is now able to view the additional television channels available under the temporary subscription. The color of the channel names 630, for example, can be switched to black, indicating they are currently viewable without any additional upgrades or temporary subscriptions. Additionally or alternatively, icons 680 are displayed to indicate to the subscriber which television channels have been added as a result of the temporary subscription.

Finally, FIG. 6G illustrates a pop-up window 690 that can be provided on the on-screen menu when the subscriber selects another temporary subscription to the same subscription package. Here, the subscriber is reminded that a temporary subscription to the subscription package has been made in the past. The pop-up window further gives the subscriber the option to purchase an upgrade to the subscription package by selecting the “monthly” button 695. Otherwise, the subscriber can cancel by selecting the “cancel” button 697 or proceed with the temporary subscription by selecting the “OK” button 693. As detailed hereinabove, other embodiments can provide similar prompts based on determining whether a threshold amount of temporary subscriptions to the selected subscription package has been made.

It should be appreciated that the specific steps illustrated in FIGS. 6A-6G provide an example of how an on-screen menu can be utilized to order a temporary subscription using the techniques provided herein Other menus, prompts, functionality, and text may also be used in alternative embodiments. For example, alternative embodiments may include recording (e.g., DVR) functionality. Furthermore, additional features may be added or removed depending on the particular applications. One of ordinary skill in the art would recognize many variations, modifications, and alternatives.

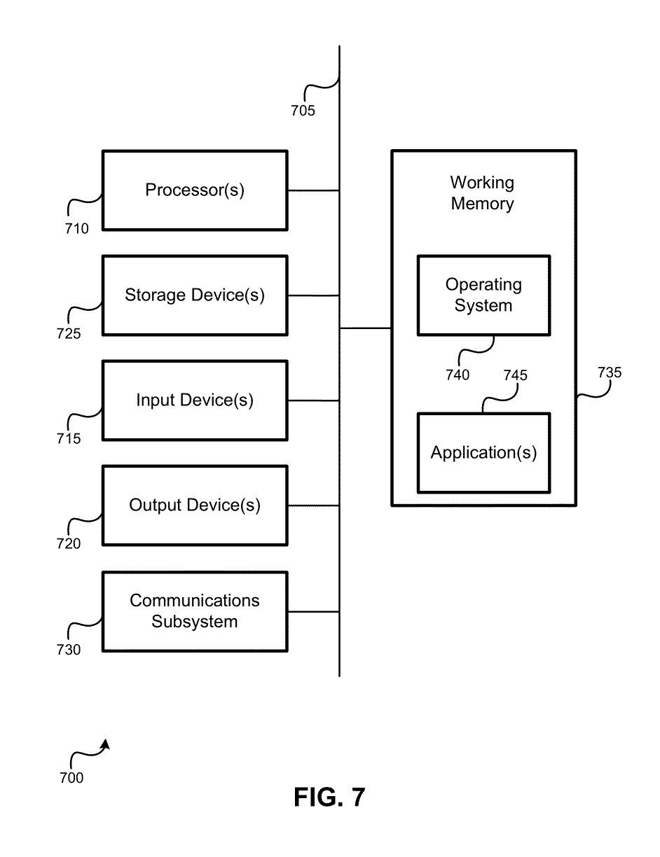

FIG. 7 illustrates an embodiment of a computer system. A computer or processing system as illustrated in FIG. 7 may be incorporated as part of computerized devices described herein, such as a television receiver 130, billing system 112, and/or access system 114 of FIGS. 1 and 2. FIG. 7 provides a schematic illustration of one embodiment of a computer system 700 that can perform the methods provided by various other embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer or processing system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a mouse, a keyboard, a remote control, and/or the like; and one or more output devices 720, which can include without limitation a television or other display device, a printer, and/or the like. Additionally or alternatively, the computer system 700 can simply include an output interface to which a separate device may be communicatively connected.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities, etc.), and/or the like. These and other communication interfaces can be used by the communications subsystem 730 to exchange data with a network (such as the data communication networks 120 of FIGS. 1 and 2, for example), other computer systems, and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments. Some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 (and/or components thereof) generally will receive signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed hereinabove are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application. Also, a number of steps may be undertaken before, during, or after the above elements are considered. Accordingly, the above description does not bound the scope of the claims.

What is claimed is:

1. A method for providing customized content programming to a content presentation device, the method comprising:
providing access to a plurality of content streams available with a first subscription package;
receiving a first request for access to a requested content stream;
determining that the requested content stream is not available with the first subscription package;
identifying a second subscription package with which the requested content stream is available;
automatically enabling a temporary subscription to the second subscription package for a certain period of time, wherein the enabling the temporary subscription allows access to the requested content stream during the certain period of time; and
restoring the first subscription package after the certain period of time.

2. The method for providing customized content programming of claim 1, wherein automatically enabling the temporary subscription to the second subscription package comprises:
sending via a data communication link a request for access to the temporary subscription to the second subscription package; and
receiving an indication that access has been granted.

3. The method for providing customized content programming of claim 1, further comprising:
indicating, on a menu presented to the content presentation device, that the requested content stream is available with the second subscription package, wherein the indicating occurs prior to receiving the first request for access to the requested content stream.

4. The method for providing customized content programming of claim 3, further comprising filtering a list of content streams such that only content streams that are available with the second subscription package are displayed on the menu.

5. The method for providing customized content programming of claim 1, wherein the certain period of time ends after:
a certain length of time,
a certain time of day, or
a certain date.

6. The method for providing customized content programming of claim 1, further including:
determining that a certain content program associated with the requested content stream comprises a program series scheduled to air at recurring time periods; and
automatically enabling a corresponding temporary subscription to the second subscription package for each of one or more of the recurring time periods the program series is scheduled to air.

7. The method for providing customized content programming of claim 1, further including:
receiving a second request for access to the requested content stream;
analyzing a history of requests for access to the requested content stream; and
providing, on a menu presented to the content presentation device, an option to change subscriptions from the first subscription package to the second subscription package, based, at least in part, on the history of requests for access to the requested content stream.

8. The method for providing customized content programming of claim 1, further comprising:
determining that a content program associated with the requested content stream will end after the certain period of time; and
providing, on a menu presented to the content presentation device, an option to extend the certain period of time.

9. The method for providing customized content programming of claim 1, wherein the first request for access to the requested content stream comprises a request to record a content program associated with the requested content stream.

10. The method for providing customized content programming of claim 9, further including:
determining that a certain content program associated with the requested content stream comprises a program series scheduled to air at recurring times; and
for each of one or more of the recurring times the program series is scheduled to air:
enabling a corresponding temporary subscription to the second subscription package, and
scheduling a recording to record a at least a portion of the program series during the recurring time.

11. A system for providing customized content programming, the system comprising:
a first communication interface configured to receive a plurality of content streams;
an output interface configured to be coupled with an end-user presentation device; and
a processing system, coupled to the first communication interface and the output interface, configured to:
enable the first communication interface to access to a plurality of content streams available with a first subscription package;
receive a first request for access to a requested content stream;
determine the requested content stream is not available with the first subscription package;
identify a second subscription package with which the requested content stream is available;
automatically enable a temporary subscription to the second subscription package for a certain period of time, such that access to the requested content stream is allowed; and
restore access to the first subscription package after the certain period of time.

12. The system for providing customized content programming of claim 11, wherein the processing system is configured to automatically enable the temporary subscription to the second subscription package by:
sending via a data communication link a request for the temporary subscription to the second subscription package.

13. The system for providing customized content programming of claim 12, further comprising a second communication interface, wherein the processing system is configured to send the request for the temporary subscription to the second subscription package using the second communication interface.

14. The system for providing customized content programming of claim 11, wherein the processing system is further configured to indicate, on a menu presented to the end-user presentation device, that the requested content stream is available with the second subscription package, wherein the indicating occurs prior to receiving the first request for access to the requested content stream.

15. The system for providing customized content programming of claim 14, wherein the processing system is further configured to filter a list of content streams such that only content streams that are available with the second subscription package are displayed on the menu.

16. The system for providing customized content programming of claim 11, wherein the system is integrated into the end-user presentation device.

17. The system for providing customized content programming of claim 11, wherein the processing system is further configured to:
determine that a certain program associated with the requested content stream comprises part of a program series scheduled to air a plurality of times; and
enable a corresponding temporary subscription to the second subscription package for each of one or more of the plurality of times the program series is scheduled to air.

18. The system for providing customized content programming of claim 11, wherein the processing system is further configured to:
receive a second request for access to the requested content stream;
analyze a history of requests for access to the requested content stream; and
provide, on a menu presented to the end-user presentation device, an option to change subscriptions from the first subscription package to the second subscription package, based, at least in part, on the history of requests for access to the requested content stream.

19. The system for providing customized content programming of claim 11, wherein the processing system is further configured to:
determine that a program associated with the requested content stream will end after the certain period of time; and
provide, on a menu presented to the content presentation device, an option to extend the certain period of time.

20. The system for providing customized content programming of claim 11, further comprising a memory, wherein the first request for access to the requested content stream comprises a request to record a program associated with the requested content stream.

21. The system for providing customized content programming of claim 20, wherein the processing system is further configured to:
determine that a certain program associated with the requested content stream comprises a program series scheduled to air at recurring times; and
for each of one or more of the recurring times the program series is scheduled to air:
enable a corresponding temporary subscription to the second subscription package, and
schedule a recording to record a portion of the program series during the recurring time.

22. A system for providing customized content programming, the system comprising:
access means for enabling an content presentation device to access to a plurality of content streams available with a first subscription package;
receiver means for receiving a first request for access to a requested content stream;
evaluation means for determining the requested content stream is not available with the first subscription package;
identification means for identifying a second subscription package with which the requested content stream is available;
enabling means for automatically enabling a temporary subscription to the second subscription package for a certain period of time, such that access to the requested content stream is allowed; and
restoring means for restoring the first subscription package after the certain period of time.

23. The system for providing customized content programming of claim 22, wherein the enabling means further comprises communication means for:
sending via a data communication link a request for access to the temporary subscription to the second subscription package; and
receiving an indication that access has been granted.

24. The system for providing customized content programming of claim 22, further comprising:
indication means for indicating, on a menu presented to the content presentation device, that the requested content stream is available with the second subscription package, wherein the indicating occurs prior to receiving the first request for access to the requested content stream.

25. The system for providing customized content programming of claim 24, wherein the indication means further comprises means for filtering a list of content streams such that only content streams that are available with the second subscription package are displayed on the menu.

26. The system for providing customized content programming of claim 22, wherein the certain period of time ends after:
a certain length of time,
a certain time of day, or
a certain date.

27. The system for providing customized content programming of claim 22, further including:
determining means for determining that a certain content program associated with the requested content stream comprises a program series scheduled to air at recurring time periods;
wherein the enabling means automatically enables a corresponding temporary subscription to the second subscription package for each of one or more of the recurring time periods the program series is scheduled to air.

28. The system for providing customized content programming of claim 22, wherein the receiver means further comprises means for receiving a second request for access to the requested content stream, further comprising:
analysis means for analyzing a history of requests for access to the requested content stream; and
presentation means for providing, on a menu presented to the content presentation device, an option to change subscriptions from the first subscription package to the second subscription package, based, at least in part, on the history of requests for access to the requested content stream.

29. The system for providing customized content programming of claim 22, further comprising:
determination means for determining that a content program associated with the requested content stream will end after the certain period of time; and
presentation means for providing, on a menu presented to the content presentation device, an option to extend the certain period of time.

30. The system for providing customized content programming of claim 22, wherein the receiver means is configured to receive the first request for access to the requested content stream that comprises a request to record a content program associated with the requested content stream.

31. The system for providing customized content programming of claim 30, further including:
determination means for determining that a certain content program associated with the requested content stream comprises a program series scheduled to air at recurring times; and
means for, for each of one or more of the recurring times the program series is scheduled to air:
enabling a corresponding temporary subscription to the second subscription package, and
scheduling a recording to record a at least a portion of the program series during the recurring time.
